(19) United States
(12) Patent Application Publication
(10) Pub. No.: US 2006/0041854 A1
(43) Pub. Date: Feb. 23, 2006

(54) Devices and methods for programming microcontrollers

(76) Inventors: Steven Schlanger, Flagstaff, AZ (US); W. Frank Ableson, Stanhope, NJ (US)

Correspondence Address: Stephen T. Sullivan, Suite 1140, 1850 N. Central Avenue, Phoenix, AZ, 85004-4586, US

(21) Appl. No.: 10/897,325

(22) Filed: Jul. 22, 2004

(51) Int. Cl. G06F 9/44

(52) U.S. Cl. 717/101

(57) ABSTRACT

A system for programming a target microcontroller. The system includes a programming information source that has a transport layer. It also includes a programming tool that includes a transport layer compatible with the transport layer of the programming information source. The programming tool also includes a plurality of command macros, a plurality of command parameters separate from the command macros, and a programmer interface. This system enables the user to send relatively limited data from the programming information source to the programming tool relative to other approaches. Communications between the programming information source and the programming tool is wireless, e.g., using optical, infrared, radio frequency, etc. The programming tool may be located in the appliance that houses the microcontroller to be programmed, and may be adjacent to or with the microcontroller. Related systems, components and methods also are disclosed.

### BACKGROUND OF THE INVENTION

1. Field of the Invention

The present invention relates to microcontrollers and related methods and, more specifically, to devices and methods for communicating with and programming and/or reprogramming microcontrollers.

2. Description of the Related Art

The term “microcontroller” as used herein is used according to its ordinary meaning in the field, to include semiconductor devices designed to control an appliance or appliance component, usually by operating a computer program or code. A microcontroller is a single integrated circuit designed to execute stored programs or instructions, wherein the entire stored program is located on the same die or substrate as the remainder of the microcontroller, and wherein the entire memory requirement for volatile or temporary storage of information needed to execute the stored program or programs is located on the same die or substrate as the remainder of the microcontroller. This can include devices designed according to the Harvard or Yale (Von Neumann) architectures. It excludes, however, microprocessors whose program and memory resources are located externally relative to the computing core, such as the microprocessors of general purpose computers.

Microcontrollers are used in a wide variety of applications and appliances. The term “appliance” as it is used herein means any a product or device which contains and uses one or more microcontrollers. This often includes products or devices that execute or display a function, for which is may be advantageous to repair, update or change such display or function without disassembly of the device. Examples of appliances are many, and would include such things as clocks, home appliances, automobiles and trucks, numerically controlled industrial machines, and many others. The microcontroller typically is “embedded” in the appliance and has a predetermined and dedicated function or set of functions that it performs in relation to the appliance. Microcontrollers come in a variety of designs and with a range of capabilities. Commercial sources of microcontrollers include Microchip Technologies, Inc. of Phoenix, Ariz. (USA), Texas Instruments, Inc. of Dallas, Tex., Atmel Inc. of San Jose, Calif., Motorola Corp. of Phoenix, Ariz.

It is assumed herein that the reader is generally familiar with the design and operation of publicly known and commercially available microcontrollers, and with publicly known and commercially available apparatus and methods for programming microcontrollers. For those wishing to obtain background on microcontrollers and programming techniques, see such publications as M. Predko, Programming and Customizing PICmicro Microcontrollers, 2d Ed., McGraw-Hill, New York, 2002. Microcontroller manufacturers also provide a wealth of publicly available data on the devices and programming techniques.

Microcontrollers typically include memory, which may comprise electrically programmable read only memory (“EPROMS”), or electrically erasable and programmable read only memory (“EEPROMS”). An example of an EEPROM would be “flash” memory. The invention as described herein is applicable to each of these types of devices, but is best suited for use with the latter two, and best suited for devices that include flash memory.

A given model of microcontroller usually comes in blank, unprogrammed form and must be programmed to perform the desired tasks associated with a given appliance or application. A manufacturer of microwave ovens, for example, may use the same microcontroller for various models of microwave oven within a given product line. Each such model typically would involve at least some different functions, and accordingly the microcontroller would have to be programmed somewhat differently for each such model. Similarly, the microcontroller used in these microwave ovens also may be used in alarm clocks, which typically would require altogether different programming to perform its differentiated tasks relative to those of the microwave ovens.

The programs for microcontrollers typically are created using a development environment operating on a development platform. A development platform typically would be a commercially available general-purpose personal computer (PC) or engineering work station. The development environment includes the software capable of creating, editing, modifying, etc. programs used or usable on a microcontroller. The development environment also may include software for performing additional tasks relevant to the overall process of preparing programs for use in a microcontroller, such as simulation of the microcontroller program, debugging software, and the like. Examples of development environments include MPLAB from Microchip Technologies, Inc.

Once the desired program has been created for a given microcontroller and application, the microcontroller itself must be programmed with the program or programs that will operate it. “Programming” as the term is used herein refers to initial programming of a new microcontroller, the modification of the program or programs in a microcontroller already in service, and/or the reprogramming of a microcontroller already in service. Programming of microcontrollers is performed according to commercially available methods and apparatus using programming tools. A “programming tool” as the term is used herein means a device that is designed and configured to program one or more types or designs of microcontroller. A programming tool generally is capable of accepting programs as provided by or from a development environment, and must be physically compatible with and capable of communication with the programming interface of the target microcontroller. Examples of commercially available programming tools include PICSTART, PICSTART PLUS, PROMATE and PROMATE II from Microchip Technologies, Inc. of Phoenix, Ariz.

These programming tools differ somewhat in their details, but generally comprise a housing with an input connection and an output connection. The input connection is connected to a programming information source, such as a development environment operating on a development platform. The output is connected to the microcontroller to be programmed, which is referred to herein as a “target microcontroller.” During initial programming of the target microcontroller, for example, in a factory setting, the target microcontroller may be separate from the appliance into which it is being installed. Alternatively, however, the microcontroller may be in the appliance while the appliance is in the process of manufacture. In the field, a technician is required to open up or partially disassemble the appliance to gain access to the target microcontroller. The programming tool then may be physically connected to the target microcontroller with a cable and connector while in the appliance, or the microcontroller may be removed from the appliance and physically connected to the programming tool. This may take place in field, e.g., at the appliance, or the target microcontroller may be taken to a repair or factory facility where it can be connected to the programming tool and re-programmed.

The specific functions and tasks performed in programming a microcontroller also vary from one circumstance to another, but usually include the following basic steps, functions or tasks: (1) Connect the programming tool to the target microcontroller to be programmed, as just described. (2) Provide appropriate power to the programming tool. (3) Establish a baseline between the programming tool and the target microcontroller. This typically involves using the programming tool to read the present state or configuration of the microcontroller, including its programmed state. (4) Erase or overwrite the appropriate portion of the microcontroller's program memory or storage space. If the microcontroller is of the EPROM type, this erasure step normally is carried out prior to use of the programming tool. If the microcontroller is of the EEPROM type or flash memory type, the programming tool applies sufficient voltage to initiate and subsequently perform the erasure. (5) The programming tool then provides the new program or programs and associated signals to the microcontroller to program or reprogram it via the tool-to-microcontroller connection. The programming tool provides the programming information in the required sequence, with the necessary timing and signal levels, to appropriately program the target microcontroller. Verification testing also may be performed to confirm the accuracy and completeness of the programming. (6) The programming tool then must be powered down, and disconnected from the microcontroller. Finally, (7) the product or appliance then must be reassembled.

A limitation associated with known methods for microcontroller programming or field applications is the conventional requirement for a programming tool. These programming tools constitute a separate item of hardware that must be available at the application site, e.g., in the field. These tools typically are complex to use, and difficult to learn how to use. The tools also usually must be capable of programming a wide variety of microcontroller types and configurations. This adds to their cost and complexity.

Physical access to the microcontroller for purposes of programming or reprogramming typically is also a significant issue, particularly for field re-programming applications. The original manufacture of appliances into which the microcontroller is to be used typically occurs in a factory or production environment, as noted above. In these types of settings, microcontrollers typically are provided in one of two forms. In one such form, the microcontrollers are programmed at the manufacturing facility of the microcontroller vendor's or provider's facility. In the second, the microcontrollers are provided without programming, and the appliance manufacturer or assembler performs the microcontroller programming at its factory. This can be done by programming the microcontroller separately and then installing it into the appliance, or by first installing the microcontroller and then programming it, also as noted above. The latter is sometimes referred to as “in circuit” programming. In each of these instances, it is common for production-level programming tools to be used. The unprogrammed microcontrollers are connected to the programming tool, and programming is carried out as generally outlined above.

In this manufacturing setting, physical access to the microcontroller may or not be problematic. In instances where the microcontroller is programmed separately from the appliance, e.g., prior to installation in the appliance, there is ready access to it. Where the microcontroller is programmed during manufacture of the appliance but after the unprogrammed microcontroller is installed into the appliance, programming generally occurs prior to closure of the appliance housing, so that the microcontroller is readily accessible.

In some instances, however, access to the microcontroller to perform programming or reprogramming can be problematic. In field applications, for example, when the appliance is being updated, maintained, repaired, etc., the microcontroller typically is enclosed in the appliance and access often is limited or precluded. Moreover, in both the factory setting as well as field settings, the need to make and secure the proper cabling and connections between the target microcontroller and the programming tool takes time, it can introduce problems, delays, etc., and thus it can increase the cost associated with microcontrollers and their use.

Some microcontrollers are pre-loaded with software that is designed to enable them to bring in programming data through their physically connected pins, and program within their own memory space. These designs, known as “self programming” or “loader program” designs, use wired connections to the programming data source, but they often do not require or use a programming tool. When instructed to do so by the appropriate input through the microcontroller pin connections, the loader program overwrites appropriate portions of the program memory space within the microcontroller, and then reprograms the microcontroller as specified by the loader program.

These loader programs, however, are subject to a number of limitations. They generally use hardwired connections. Moreover, during overwrite, if the loader program overwrites an inappropriate memory space, or too much memory space, for example, by overwriting itself, it can render the microcontroller unprogrammable. This can destroy the ability to program it without major effort and expense, typically including removing the microcontroller from the appliance or field setting and reprogramming it in a factory or maintenance facility using a production-type programming tool, often having specially adapted capabilities to reprogram the microcontroller under these specific circumstances. Microcontrollers with loader programs also are limited in that they typically require an uninterrupted data stream to accomplish the reprogramming without errors or difficulties. If programming is interrupted at any stage, then the program function may be random, unpredictable or inoperative.

Another limitation of loader programs is that they require and thus consume limited and valuable resources of the target microcontroller, for example, such as program memory space. Given the usual circumstance in which memory space in the target microcontroller is severely limited, and the desire to devote as many target microcontroller resources to the normal operational tasks of the target microcontroller, this impingement upon precious resources can be problematic. It also can increase the requirements of the target microcontroller, which in turn can drive up the costs and complexity associated with the target microcontroller.

### OBJECTS OF THE INVENTION

Accordingly, an object of the present invention according to certain aspects is to provide devices and methods that enable efficient and cost effective programming and/or reprogramming of microcontrollers.

Another object of the invention according to certain aspects is to provide devices and methods that enable microcontrollers to be programmed and/or reprogrammed with increased speed relative to known methods.

Another object of the invention according to certain aspects is to provide devices and methods that enable microcontrollers to be programmed and/or reprogrammed in field settings with increased ease, speed and/or flexibility over known methods.

Additional objects and advantages of the invention will be set forth in the description, which follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, a system is provided for programming a target microcontroller, wherein the system comprises a programming information source and a programming tool, and further wherein the programming information source and the programming tool each comprise wireless communication subsystems so that the programming information source and the programming tool communicate with one another wirelessly. The wireless communication mode may comprise any of a number of wireless modes, including but not limited to optical, such as infrared, radio frequency (RF), and others. The invention according to related aspects comprise a programming information source with a wireless communication subsystem, and a programming tool with wireless communication subsystem. The programming information source may comprise a portable device such as a personal data appliance. The programming tool may be located with or adjacent to the target microcontroller, and optionally may reside in the appliance that houses the target microcontroller. Related methods for communicating wirelessly in the microcontroller programming context also are included.

In accordance with another aspect of the invention, a programming tool is provided for programming a target microcontroller. The programming tool comprises a transport layer, a command macros memory, a command parameters memory and a programming interface.

In accordance with another aspect of the invention, a programming tool is provided for use with a target microcontroller in an appliance. The programming tool is located in the appliance, but separate from the microcontroller. In accordance with another aspect of the invention, a programming tool is provided for use with a target microcontroller, where the programming tool is located with the target microcontroller, but is separate from the microcontroller. Preferably the programming tool does not use or require the resources of the target microcontroller, such as the program memory of the target microcontroller. The programming tool according to these aspects of the invention may be located on the same circuit board. The programming tool also may be located on a board co-located with the microcontroller but separate from it.

In accordance with another aspect of the invention, a programming tool is provided for use with a microcontroller, wherein the programming tool is integrated into or located on a single chip with the target microcontroller. The programming tool preferably comprises a transport layer, a command macros memory, a command parameters memory and a programming interface.

In accordance with separate but related aspects of the invention, the programming tool according to each of the aforementioned aspects of the invention may comprise part of a system that includes a programming information source.

In accordance with yet another aspect of the invention, a system is provided for programming a target microcontroller. The system comprises a programming information source and a programming tool, each having the ability to communicate wirelessly between the programming information source and the programming tool. The form of wireless communication optionally may comprise optical, for example, such as infrared communication, radio frequency (RF), or others. Where the programming tool is located in the appliance, a window or other transmission conduit that is transparent or substantially so preferably is provided in the apparatus to allow the wireless transmission through the exterior of the appliance and to the programming tool.

In accordance with another aspect of the invention, a portable programming device is provided for programming a target microcontroller. The portable programming device according to a presently preferred embodiment comprises a personal data accessory (PDA), preferably a commercially available PDA, programmed and/or configured to serve the desired programming function.

In accordance with still another aspect of the invention, a method is provided for obtaining a circular redundancy checks.

In accordance with other aspects of the invention, various methods are provided for programming a target microcontroller. According to one such method, a programming information source, preferably a PDA, and a programming tool are provided. The programming tool preferably is located within the appliance that houses the target microcontroller. The programming tool may be incorporated into the same chip as the target microcontroller. It also may be provided on the same printed circuit board as the target microcontroller. Alternatively, the programming tool may be disposed on a board separate from the target microcontroller. The method preferably comprises communicating command macros and command parameters separately from the programming information source to the programming tool, or segregating command macros from command parameters at the programming tool. A similar method comprises using command macros at the programming tool to communicate programming information to the target microcontroller. In each instance, preferably the programming tool carries out its functions without relying upon the resources, particularly the program memory, of the target microcontroller. In these methods, the communication between components, and particularly between the programming information source and the programming tool are wireless. The wireless mode may comprise optical, such as infrared, using radio frequency communications, and others.

The invention according to additional but related aspects comprise systems for programming a target microcontroller.

In the presently preferred embodiments and preferred method implementations according to the invention, the target microcontroller is identified, the programming code is selected, a link between the programming information source and the programming tool, preferably wirelessly, parameters and meta-data corresponding to the target microcontroller are sent over the link, command macros containing representations of the contents of the programming code are sent over the link, and the programming tool returns macros indicating status and providing reports on verification of the macros operation.

### BRIEF DESCRIPTION OF THE DRAWINGS

The accompanying drawings, which are incorporated in and constitute a part of the specification, illustrate presently preferred embodiments and methods of the invention and, together with the general description given above and the detailed description of the preferred embodiments and methods given below, serve to explain the principles of the invention. Of the drawings:

FIG. 1 is a functional block diagram of an illustrative target microcontroller;

FIG. 2 is a functional block diagram of known systems and configurations for programming a target microcontroller;

FIG. 3 is a functional block diagram of a system, including a programming tool, according to a first preferred embodiment of the invention according to certain aspects;

FIG. 4 is a flow diagram showing processing flows for a bulk erase process performed in connection with the preferred embodiment of FIG. 3;

FIG. 5 is a diagram showing the pin assignments for a single chip programming tool used in the preferred embodiments of FIGS. 3, 6 and 16;

FIG. 6 is a functional block diagram of a system, including a programming tool, according to a second preferred embodiment of the invention according to certain aspects;

FIG. 7 is a functional block diagram of a PDA according to another preferred embodiment of another aspect of the invention;

FIG. 8 is a pictorial diagram of a first screen display for the PDA of FIG. 7 and related preferred method implementation;

FIG. 9 is a pictorial diagram of a screen display for the PDA of FIG. 7 and related preferred method implementation, used to select the target microcontroller;

FIG. 10 is a pictorial diagram of a screen display for the PDA of FIG. 7 and related preferred method implementation, used to select program files to be communicated to the microcontroller or deleted;

FIG. 11 is a pictorial diagram of a screen display for the PDA of FIG. 7 and related preferred method implementation, used to download a new program file from a development environment, a wide area network, the Internet, or other indirect distribution source;

FIG. 12 is a pictorial diagram of a screen display for the PDA of FIG. 7 and related preferred method implementation, used to select the method or mode of wireless communication to the programming tool;

FIG. 13 is a pictorial diagram of a screen display for the PDA of FIG. 7 and related preferred method implementation, used to open or start communication with the programming tool;

FIG. 14 is a pictorial diagram of a screen display for the PDA of FIG. 7 and related preferred method implementation, used to display the program codes either read from the target microcontroller or loaded by the programming file from a development environment;

FIG. 15 is a pictorial diagram of a system, including a programming tool, according to another preferred embodiment of the invention according to certain aspects;

FIG. 16 is a functional block diagram of the system and programming tool of FIG. 15; and

FIG. 17 is a functional block diagram of a system according to another preferred embodiment of the invention according to certain aspects, which system comprises wide area distribution of programming data to single or multiple programming information sources, such as PDAs.

### DETAILED DESCRIPTION OF THE PREFERRED EMBODIMENTS AND METHODS

Reference will now be made in detail to the presently preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in this section in connection with the preferred embodiments and methods. The invention according to its various aspects is particularly pointed out and distinctly claimed in the attached claims read in view of this specification, and appropriate equivalents.

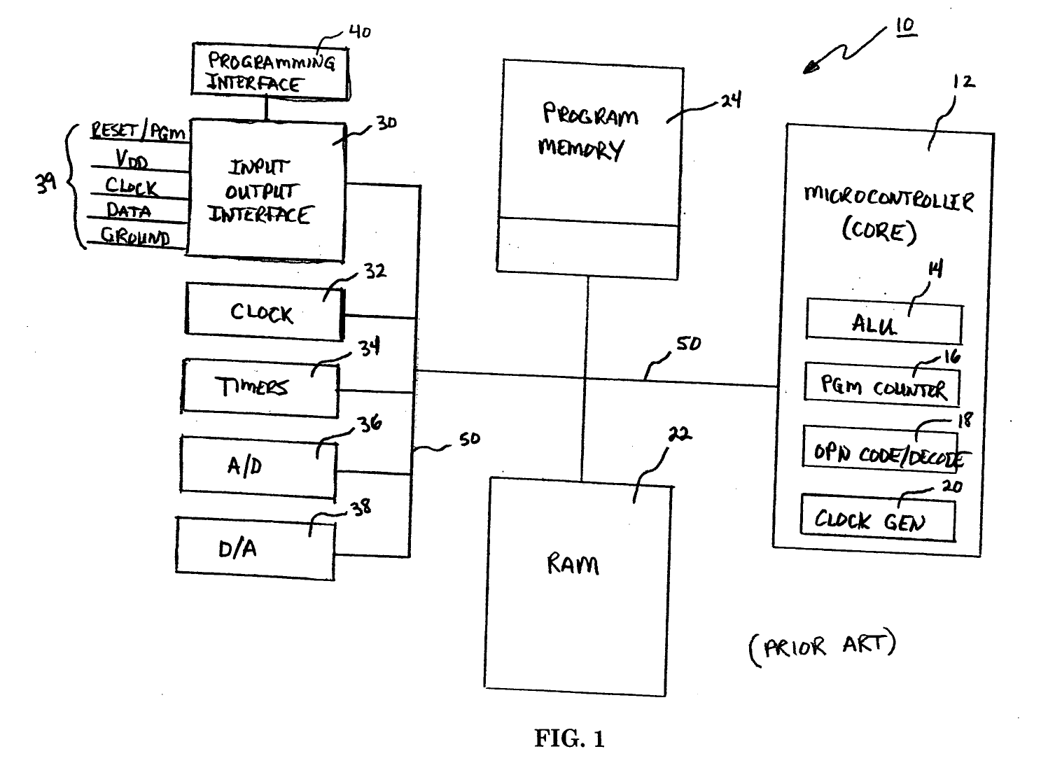

A summary of illustrative microcontroller architecture will now be provided to better illustrate the principles of the invention and to aid in the description of the presently preferred embodiments and methods according to the invention. FIG. 1 shows a general functional block diagram of the architecture for a representative and illustrative target microcontroller 10. It uses the well-known reduced instruction set (RISC) architecture. Target microcontroller 10 includes a central processing unit (CPU) or microcontroller core 12, which comprises an arithmetic-logic unit (ALU) 14, a program counter 16, an operational coder/decoder 18, and a clock generator 20.

Target microcontroller 10 also includes random access memory (RAM) 22, which comprises the volatile storage used when the microcontroller 10 is powered on to store either permanently or semi-permanently any data or values that are needed by the microcontroller core 12 while it performs its operations.

Microcontroller 10 also includes program memory or program storage 24 for storing the programs used by target microcontroller 10 during its normal operations. Once initially programmed, typically at the factory when microcontroller 10 is new or is newly installed into an appliance, these programs typically are not changed unless they undergo a major repair, upgrade, or the like. Program memory 24 may comprise read only memory (ROM), erasable programmable memory (EPROM), electrically erasable read only memory (EEPROM), or flash memory. For purposes of the present invention, program memory 24 is assumed to be programmable.

Target microcontroller 10 further includes an input-output (I/O) interface 30, a clock 32, timers 34, it may or may not include one or more analog-to-digital (A/D) conversion circuits 36, and/or one or more digital-to-analog (D/A) conversion circuits 38.

Input/output interface 30 includes five lines, i.e., a reset and program line (RESET/PGM), a voltage supply line (VDD), a clock line (CLOCK), one or more data lines (DATA), and a ground line (GROUND). The DATA line typically is a serial data bus. The RESET/PGM, CLOCK and DATA lines together typically are referred to as a “program bus,” identified herein by reference numeral 39. These pins associated with I/O interface 30 typically are configurable to allow and facilitate effective communication with a wide range of peripheral devices. A programming interface 40 controls if I/O interface 30 is used for general I/O pin during normal mode, or used as programming pins.

Clock 32 provides a real time, general purpose clock. Timers 34 allow the target microcontroller 10 to time certain events, trigger interrupts, and the like. A/D converters 36 are for conversion of analog input voltage levels or signals into digital values for use in processing by microcontroller core 12. D/A converters 38 make the reverse conversion, i.e., from digital to analog, typically for outputs.

Programming interface 40 controls the interfacing with a programming tool or similar device. One or more pins that are available at I/O interface 30 serve double duty, functioning as general purpose input pins during normal operations, when the microcontroller is not being programmed, and they function as a programming pin or pins only when the microcontroller 10 is being programmed. These dual-function pins serve as programming pins only when microcontroller 10 is put into its programming mode. Once programming is completed, those pins revert to their normal function.

In microcontroller 10, which is a RISC-type microcontroller described here merely for illustrative purposes, a general data bus 50 is used to provide connectivity between microcontroller core 12 and other components of microcontroller 10 that are accessed by registers, namely RAM 22, program memory 24, I/O interface 30, clock 32, timers 34, A/D converters 36 and D/A converters 38. These registers are mapped into the RAM 22 space.

To further provide background useful in illustrating the principles of the invention and its presently preferred embodiments and methods, we will now provide a brief overview of the manner in which microcontrollers commonly are programmed according to known methods. As noted herein above, microcontrollers normally are initially programmed at the factory, either by the microcontroller manufacturer, the original equipment manufacturer (OEM), or an applications manufacturer or assembler. The microcontrollers also may require re-programming during their service life. Although in some instances this reprogramming can be done in the field (for example, at the site where the appliance is located and the microcontroller is in service). This reprogramming typically is carried out at a factory or maintenance facility.

Reprogramming typically involves modifying or replacing the contents of the program memory, which in microcontroller 10 involves program memory 24, so that the functions performed by the microcontroller 10, and usually as a result the functioning of the appliance in which the microcontroller is contained or embedded, is changed.

The process of programming a microcontroller, whether initial programming or subsequent reprogramming, usually includes the preliminary step of creating the program or programs to be placed in the target microcontroller's program memory 24 and used operationally by the microcontroller. This typically is accomplished using a development environment. The development environment usually involves a suite of software products useful for creating microcontroller programs and getting those programs loaded onto the target microcontroller. These software products typically include software for designing or modifying microcontroller programs, debugging them, testing them or verifying their operation, simulating the performance of the microcontroller software in a pseudo-operational setting, compiling it, and in some cases including programming the microcontroller.

It also is common in microcontroller programming to use a “programming tool” to accomplish the programming task. Once the program for operational use in the microcontroller has been created, it is necessary to physically transfer that program into the target microcontroller, usually into the program memory 24. Programming tool 70 converts the information (the file or files) that is to reside in the program memory and converts it into serial data. It also causes the serial data stream to be accompanied by the appropriate programming voltages on the programming pins of the target microcontroller and the associated timing. Programming tool 70 also typically supports certain commands. Programmer 70, for example, normally would be configured to carry out certain commands from the development platform, such as reading the contents of microcontroller program memory 24, erasing or overwriting selected memory contents, writing to program memory 24, verifying the contents of program memory, for example, to ensure that a write command was properly carried out, resetting the microcontroller, and so forth. Typically the commands are simply commands used by microcontroller 10 itself, but they have to be conveyed from some type of a command structure within the programming tool. These commands must be converted into a corresponding command that is useable by the microcontroller 10.

There are a variety of programming tools commercially available for this purpose. They vary based on the particular manufacturer's design, the microcontroller or microcontrollers the programming tool is designed to service, the volume of programming that is anticipated, and the like.

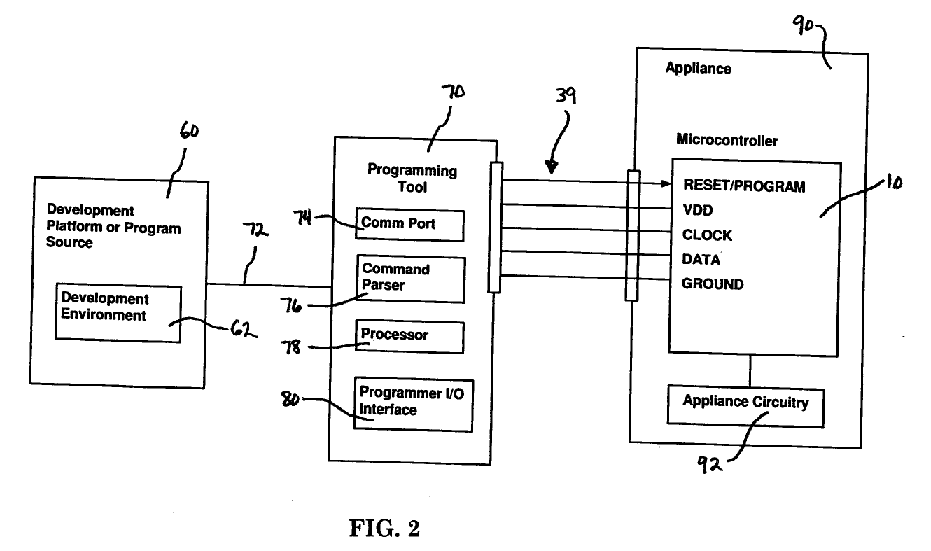

FIG. 2 shows an illustrative schematic diagram of an equipment configuration for programming microcontrollers according to known methods. A development platform 60, typically a personal computer (PC) or a small business computer located at a factory or service center, or a laptop computer, is configured with a development environment software 62, both as generally described herein above. This development platform and environment are used to create the program to be loaded into target microcontroller 10. The program for the target microcontroller also may be created on the development platform 60, and then transferred to a laptop computer, which in FIG. 2 may be depicted by block 60 with respect to physical configuration for carrying out the programming.

The development environment or laptop computer 60 serving as the program source is connected to a programming tool 70 via line 72 that comprises, a serial data bus, a universal serial bus (USB), or the like. The data transferred from development environment 60 to programming tool 70 includes address data, commands, programming code, and parity data, plus any setup information required by the programming tool. The program file may or may not include any of the parameters that are required for programming, and it does not include any of the definitions of commands or similar data.

Programming tool 70 includes a communications port 74, a command parser 76, a processor 78, and a programmer input/output interface 80. Communications port or programming interface 74 applies the various voltages and converts the data to be transferred to the target microcontroller into serial form to accomplish programming of the target microcontroller. Command parser 76 takes the data from the file format as received from communications port 74 and converts it into the proper format to program the target microcontroller. Programming tool 70 includes as output lines corresponding to the RESET/PGM, VDD, CLOCK, DATA, AND GROUND lines of target microcontroller I/O interface 30, i.e., program bus 39.

It is noteworthy that the commands required to program a particular target microcontroller vary from microcontroller to microcontroller, so when the programming tool is being used to program, for example, a Microchip Technology Part No. 12F629, different commands would be required as compared to those needed to program a 16F part. This information is not stored within the programming tool, but instead is stored in the development platform, or in the laptop or other program source. The standard practice for translating these commands involves the use of a dynamic link library, which typically is stored as part of the development environment 62 or is stored on the program source, such as a PC. When programming a given microcontroller, the development environment selects the dynamic link library entry for that microcontroller and as a result commands that are needed for that microcontroller are drawn into the development environment through that dynamic link library. In summary, the program source must be configured to program the specific microcontroller to be programmed, and the appropriate dynamic link library must be provided to ensure that the appropriate commands are provided to the microcontroller.

These commands are transported from the development platform or other program source, such as a PC, over a serial link to the programming tool. Some programming tools include memory, typically to buffer some or all of the program, but the storage space typically is limited.

Target microcontroller 10 in this illustrative example is located in an appliance 90, although these need not be the case. Microcontroller 10 in this example is coupled to appliance circuitry 92. This appliance circuitry is used to perform the functions of the appliance, e.g., such as light-emitting diodes, an alarm, and the like. Appliance 90 has been opened in this example to provide an access port 94 through which physical access to microcontroller 10 can be gained.

The technician performing the programming operation first gains access to the target microcontroller 10, for example, by opening appliance port 94. He or she then physically connects the programming bus 39 from programming tool 70 to I/O interface 30 of microcontroller 10. He or she also makes the physical connection from the development platform or laptop computer 60 to the programming tool 70 using serial data bus 72.

After the physical connections are made, the programming procedure is begun. According to that procedure, the power is turned off at the VDD line so it is at ground level. The RESET/PGM line is then raised above the normal operating voltage, for example, to 12 volts. Power is then applied at the VDD line. The high voltage (e.g., 12 volt) signal on the RESET/PGM line causes the target microcontroller 10 to leave its reset condition and enter into in its programming mode.

To transfer data to the target microcontroller, a clock signal is applied on the CLOCK line. With each falling edge of that clock signal, a data bit is read from the DATA line. If the signal is high at a falling edge of the clock signal, then the bit is assumed to be high. If the voltage level on DATA line is low, then the bit has a zero value.

Because the DATA line is normally a serial data bus, the DATA signal changes state only when the bit value is changed. If eight ones are clocked to the microcontroller 10 to transfer an FF, for example, the DATA line would simply remain high and only clock pulses would be transferred. The command to write a byte into the microcontroller 10 would comprise a number of bits to indicate the command, 6 bits followed by 16 bits of the data. These would be clocked in one bit at a time, 16 plus 6 bits, through the combination of the CLOCK line and the DATA line. This step would be repeated for the entire program memory.

In these known programming system configurations, the programming tool is a separate component, physically separated from and spaced from the development platform 60 and the target microcontroller 10. The connections between the development platform 60 and the programming tool 70 are physical electrical connections, typically a serial data bus or USB connection, suitable for communicating the necessary data from one device to the other. Similarly, the connection between programming tool 70 and target microcontroller 10 typically is a wired connection that is suitable for communicating signals and data required for controlling and manipulating the microcontroller as appropriate to perform the programming functions. As noted herein above, when one desires to program a given microcontroller, it is necessary to physically connect the development platform or program source 60 to programming tool 70, and to physically connect programming tool 70 to target microcontroller 10. These connections are made using detachable electrical connectors commonly found with serial data lines. This connection arrangement has been disadvantageous in a number of respects, as noted herein above.

In accordance with one aspect of the invention, a programming tool is provided for programming microcontrollers, wherein the programming tool comprises a transport layer, a plurality of command macros, a plurality of command parameters separate from the command macros, and a programmer interface.

In accordance with another aspect of the invention, a system is provided for programming a microcontroller wherein the system comprises a programming information source and a programming tool. The programming information source comprises a transport layer and first programming information for programming the microcontroller. The programming tool comprises a transport layer compatible with the transport layer of the programming information source. The programming tool also comprises a plurality of command macros, a plurality of command parameters separate from the command macros, and a programmer interface.

The programming tool and the system as described herein in connection with the preferred embodiment enable one to have significantly greater flexibility, for example, to divide the program information and related commands between the programming information source and the programming tool, and thus to reduce, in some cases substantially, the amount of data that must be communicated between the programming information source and the programming tool. This can afford substantial benefit, for example, in enabling implementation of wireless communications of the programming information between the programming information source and the programming tool.

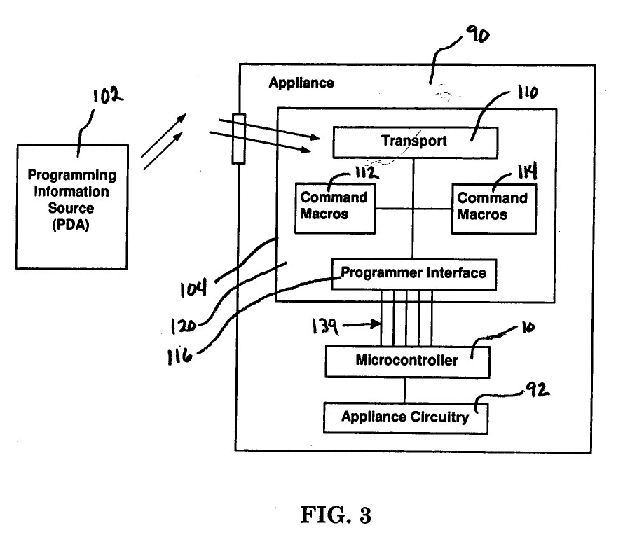

To describe and illustrate these aspects of the invention, a presently preferred but merely illustrative embodiment of them is shown in FIG. 3, and will now be described. With reference to FIG. 3, a system 100 is provided for programming a target microcontroller, which in this illustrative case is assumed to be target microcontroller 10. For purposes of this example, microcontroller 10 is assumed to physically reside in appliance 90, and to be operatively coupled to appliance circuitry 92.

System 100 comprises a programming information source 102. Programming information source may comprise any device or apparatus that contains and/or can convey programming information useful for programming a target microcontroller. Examples of devices suitable as programming information source 102 would include a development platform such as platform 60 in FIG. 2, a PC or like computer, or a portable electronic device capable of storing and communicating the programming information. Examples of such portable devices may include, for example, a custom built, hand held device specifically designed for the task of storing and selectively communicating the programming information. In the presently preferred embodiment, programming information source 102 comprises a personal data accessory (PDA) or the like, and preferably a general commercially available PDA, as will be described and explained more fully herein below.

System 100 further comprises a programming tool 104. In this preferred embodiment, programming tool 104 is located adjacent to microcontroller 10, and more preferably, is located within apparatus 90. These incidentally comprise further aspects of the invention. Programming tool 104 is operatively coupled to microcontroller 10.

Programming tool 104 comprises a transport layer 110. The transport layer is responsible for moving the data between the programming information source and the programming tool of the presently preferred embodiments. This transport layer may comprise or constitute a hardwired connection with programming information source 102. Alternatively, and in accordance with another aspect of the invention as described more fully below, transport layer 110 may comprise a wireless transport layer for wireless communication between programming information source 102 and programming tool 104. This wireless transport layer may comprise, for example, an infrared transport layer, an optical transport layer, a radio frequency transport layer, and many other wireless communication means and approaches.

Programming tool 104 also comprises a command macros memory or storage 112 and a command parameters memory or storage 114, both of which are operatively coupled to transport layer 110.

In a known programming operation, the program source, which usually is a PC, transfers the programming information that is stored in the form of a hex file to some form of storage in the programming tool. The programming tool then takes the stored data and programs the target microcontroller.

In the presently preferred embodiments, command data for commands normally received by the programming tool 104 are segregated into command macros and command parameters. Accordingly, programming tool 104 comprises a command macro memory 112 and a command parameters memory 114 form the core of what are called the “protocols” for programming the target microcontroller.

The programming information communicated from programming information source 102 comprises commands to be programmed into the target microcontroller 10, as noted above. In this preferred embodiment and corresponding preferred methods of implementation, these commands comprise command macros. A command macro as the term is used here comprises a command that may include one or more sub-commands or lower level commands. The command macro function is the ability to send a series of commands which are normally repeated during the programming process and have those execute as a single command from the programming device.

To illustrate, in the process of programming microcontroller, it is often necessary to repeat a command or series of commands in a particular way. For example if one were going to write to a particular memory location that would always be followed by a command to advance the program memory counter to the next memory location and wait for the programming cycle time to end so the command macro function allows us to string together normal commands so that they need not be repeated over the transportation layer so in order to program ten cycles, ten memory locations with a traditional programmer, one would first write to a location, advance to the next location, wait, and then repeat. This series would be repeated ten times. Those commands therefore would have to be repeated ten times over the communication link between the programming tool and the target microcontroller.

With the presently preferred embodiment as described here, this is not required, in large measure because of the command macro function. It eliminates large numbers of repeated or redundant commands. Through the design and implementation of the preferred embodiment, including the command macro function, the series of commands is communicated together with an instruction to repeat them N times.

Command macros memory 112 receives and processes these command macros. When a command macro is received, command memory is used to call up the list or collection of commands within that command macro, and to cause those commands to be performed. So, for example, in the necessary function of stepping through the program memory and retrieving a single program memory value, typically in a known programmer the command would be sent to advance the program memory counter. This command then would be repeated N times to get the desired location.

It normally would be necessary for the programming information source to provide multiple instructions or commands, and for those commands to have been re-issued to target microcontroller 10. Each of those commands might have to be repeated thousands of times, for example, to get to the appropriate program memory value or, in the case of a more complex operation like programming a memory location, a series of specific parameters and commands would be involved. For example, when writing to a program memory location, a delay is required to allow the programming cycle to be completed. Typically, in known methods, the program counter must be advanced, then the entire program memory read back to ensure or verify that the programming process was accomplished without error.

In the presently preferred embodiment as described here, a program N words macro is invoked. The programming tool writes the program word, delays, verifies the individual word, advances the program counter, then reports back to the programming information source if the process was accomplished without error. The program command need only be issued once using the program macro. The programming verification is accomplished at the same time as programming, which eliminates the need for reading back the contents of the programmed part.

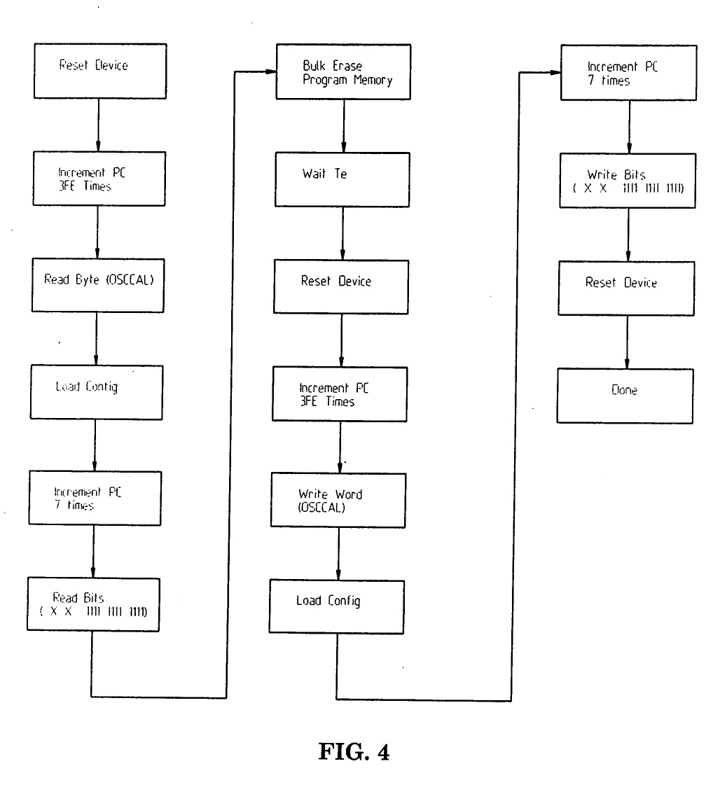

An example of a command macro is shown in flow chart form in FIG. 4. This diagram is a preferred embodiment of the macro for erasing an entire target microcontroller. The procedure is commonly referred to as “bulk erase.”

Command macros are used with command parameters. For example, typical parameters would include the time required to erase the program memory of the target microcontroller, the time required to program a memory location, or the number of bits per program word.

In known microcontroller programming techniques, the development environment or the program information source, such as the PC, using the dynamic library, communicates commands as described above, and uses command parameters as they are needed in carrying out these commands.

The command parameters can be prestored in command parameter storage 114, or they can be provided by the program information source, e.g., PDA, and separately stored in memory 114. via when the device is sold and/or could be updated when the target microcontroller type is selected. In the preferred embodiment and preferred implementations, this command parameter storage 114 is non-volatile. This storage therefore need not be updated unless the target microprocessor type changes.

Programming tool 104 further comprises a programmer interface 116 operatively coupled to microcontroller 10. Programming interface 116 is the hardware interface that allows the programming information to be written into the microcontroller program memory. The programming interface comprises the set of physical signals used to interface to the target microcontroller 10. In International Standards Organization (ISO) terms, the programming interface is the physical layer that is used to transport the data to the target microcontroller when in programming mode. Programmer interface 116 comprises five output pins of programming bus 39 of microcontroller 10 in FIG. 1.

In accordance with another aspect of the invention, programming tool 104 may be integrated into a single semiconductor chip or substrate with microcontroller 10.

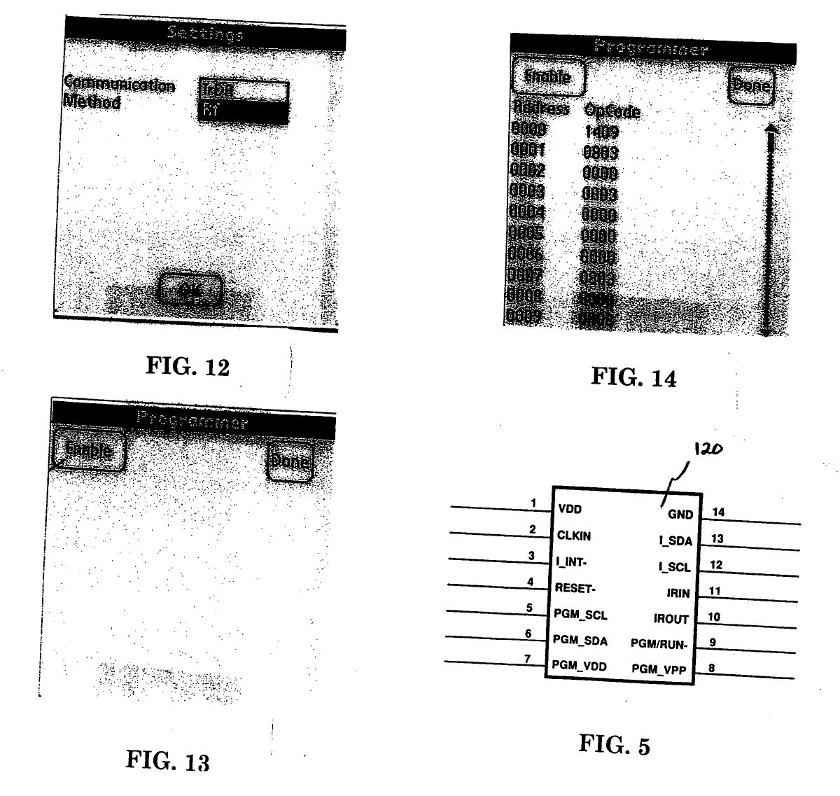

In the physical implementation of the presently preferred embodiment as described herein, programming tool 104 comprises microcontroller 120, which comprises a Microchip Model 16F684 microcontroller chip, commercially available from Microchip Technology, Inc., and programmed appropriately to carry out the functions as described herein. The pin assignments for microcontroller 120 are shown in FIG. 5. The pin descriptions are provided in Table 1, herein below.

TABLE 1
PIN DESCRIPTIONS FOR PROGRAMMING TOOL
MICROCONTROLLER CHIP
Pin Description:

| Pin | Name | Type | Description |
|---|---|---|---|
| 1 | VDD | P | Power Supply 2.7 V to 5.5 V |
| 2 | CLKIN | I | Ext Clock Input |
| 3 | I_INT | O | Interrupt service request for I²C bus |
| 4 | RESET- | I | Device Reset |
| 5 | PGM_SCL | O | Programming serial clock |
| 6 | PGM_SDA | I/O | Programming serial data |
| 7 | PGM_VDD | O | Output to device Vdd |
| 8 | PGM_VPP | O | Output to device Vpp |
| 9 | PGM/RUN- | O | Output, control for Vpp Driver |
| 10 | IR_OUT | O | Ir Transmit Data |
| 11 | IR_IN | I | Ir data from Transceiver |
| 12 | I_SCL | I | I²C Bus Clock |
| 13 | I_SDA | I/O | I²C Bus Data |
| 14 | GND | P | Power Supply Ground |

The command macros for chip 120 are as follows. As noted above, this command set is invoked if the Program Mode is selected.
Command Frame Format: [C] [N] [Data . . . ]
Command word, 8 bits as defined below. Undefined commands will be ignored. The command is sent hi byte, lo byte.
N=Number of data words to be read/written, 8 bits. A maximum of 8 words (16 bytes) are allowed per data frame. N must be nonzero. Chip 120 indicates a failed operation by returning N=0 in a response.
Data=Field of N data words. Data words are always 16 bits, sent hi byte, lo byte. Program Data words and 8-bit EEPROM bytes must be padded as follows:
8-bit EEPROM word: 0 (8 data bits) 0000000

14-bit program word: 0 (14 data bits) 0

| Description | Value | Decription |
|---|---|---|
| Master Reset | 00 | Sets PC = 0 by performing a hardware reset. |
| | | N = none, Data = none |
| | | Returns = C, N |
| Program Memory | 01 | Programs and verifies N words into program memory space. The |
| | | address |
| | | Counter is incremented by N. |
| | | N = nonzero number of Program words, Data = field of words (<=8) |
| | | Returns = C, N if successful, N = 0 if not successful. |
| Program Data Memory | 02 | Programs and verifies N EEPROM words. The address counter is |
| | | incremented by N. |
| | | N = nonzero number of data words, Data = field of words (<=8) |
| | | Returns = C, N if successful, N = 0 if not successful. |
| Read Program Memory | 03 | Reads Program Memory words and returns them to the Primary. The |
| | | address counter is incremented by N. |
| | | N = nonzero number of Program words, Data = field of words (<=8) |
| | | Returns = C, N if successful, N = 0 if not successful. |
| Read Data Memory | 04 | Reads data EEPROM memory words and returns them to the Primary. |
| | | The Address counter is incremented by N. |
| | | N = nonzero number of Data words, Data = field of words (<=8) |
| | | Returns = C, N if successful, N = 0 if not successful. |
| Increment Address | 05 | Increments the Address counter N times. |
| | | N = nonzero number of times to increment, Data = none |
| | | Returns = C, N |
| | | Note: N is 8 bits maximum, 255 increments |
| Set Device Parameters | 06 | Sets various parameters for the device: |

| | | |
|---|---|---|
| Parameter | Sym | Desc |
| 0 | Te | Erase time (100's of uS), one byte |
| 1 | Tp | Program Time (100's of uS), one byte |
| 2 | I_addr | I²C Bus Address |
| 3 | lomask | low byte read mask, 0xFE for 14-bit words |
| 4 | himask | hi byte read mask, 0x3F for 14-bit words |
| 5 | cmd0 | Load Configuration Memory |
| 6 | cmd1 | Load Data for Pgm Memory |
| 7 | cmd2 | Load Data for Data Memory |
| 8 | cmd3 | Read Data from Pgm Memory |
| 9 | cmd4 | Read Data from Data Memory |
| 10 | cmd5 | Increment Address |
| 11 | cmd6 | Begin Programming |
| 12 | cmd7 | End Program, No Operation if bit7 = 1 |
| 13 | cmd8 | Bulk Erase Program Memory |
| 14 | cmd9 | Bulk Erase Data memory |

| | | |
|---|---|---|
| | | The N parameter indicates the number of parameters to be sent. |
| | | Returns = C, N |
| Set PC to Config memory | 07 | Sets Address counter to the 1st address of the configuration memory, |
| | | typically 0x2000. |
| | | N = 01, Data = none |
| | | Returns = C, N |
| Bulk Erase Program Memory | 08 | The Address counter must be set to Configuration Memory before |
| | | executing this command. |
| | | This command executes as follows: |
| | | a.) Bulk Erase Program Command = 001001 |
| | | b.) Wait Erase Time |
| | | N = 01, Data = none |
| | | Returns = C, N |
| Bulk Erase Data Memory | 09 | The PC must be set to Configuration memory before executing this |
| | | command. |
| | | This command executes as follows: |
| | | a.) Bulk Erase Data Command = 001011 |
| | | b.) Wait Erase Time |
| | | N = 01, Data = none |
| | | Returns = C, N |
| No Operation | 0A | This command is used to check the status of the IrDA link. This |
| | | command has no effect, other than to generate a return. |
| | | N = 01, Data = none |
| | | Returns = C, N |
| Write Literal Command | 0BXX | This command allows the Primary device to enter programming |
| | | commands directly into the device being programmed. This command |
| | | bypasses the protocol layer to gain direct access to the hardware of the |
| | | target micro. |
| | | XX = right aligned command byte, typically 6 for PIC micros. |
| | | N and Data are not implemented in this command |
| | | Example: |
| | | Begin Programming Command (12F629) = 001000 (6 bits) |
| | | Write Literal command sequence = [0B] [08] |
| Write Literal Word | 0CXXXX | This command allows the Primary device to write a 16-bit word |
| | | directly into the device being programmed. This command bypasses |
| | | the protocol layer to gain direct access to the hardware of the target |
| | | micro. |
| | | XXXX = 16 bit word, padded with zeroes as needed. |
| | | N and Data are not implemented in this command |
| | | Example: |
| | | Program 14-bit 0x3FFF into 16-bit word padded with zeroes |
| | | Write Literal command sequence = [0C] [7F] [FE] |
| Read Literal Word | 0DXXXX | This command allows the Primary device to read a 16-bit word |
| | | directly from the target device. This command bypasses the |
| | | protocol layer to gain direct access to the hardware of the target micro. |
| | | XXXX = 16 bit word, padded with zeroes as may be implemented by the |
| | | target micro. |
| | | N and Data are not implemented in this command |
| Read Bulk | 0EXXXX | This command starts a bulk read of Program Memory starting at the |
| | | current address. The following 16 bits is the count of words to dump. |
| | | Chip 120 will then dump the contents of Program Memory as fast as the |
| | | transport layer will allow. This command may only be cancelled by the |
| | | Read Bulk Cancel command. |
| | | The format of the returned data will be: |
| | | [03][XX][Data words . . . ] |
| Read Bulk Cancel | 0F | This command cancels the Read Bulk procedure. Chip 120 will return |
| | | N = 1. |
| Blank Check | 10 | This command checks a range of Program and EEPROM. The |
| | | Program and EEPROM Data read masks are applied and if any bits are |
| | | clear the device return N = 1, otherwise N = 0. Syntax: |
| | | 10 AA BBBB CCCC |
| | | AA = Number of ranges to check, 1 or 2 |
| | | BBBB = 16 bits of Program words to check |
| | | CCCC = 16 bits of Data EEPROm words to check |

In accordance with another aspect of the invention, a portable programming information source is provided. This portable programming information source forms a separate aspect of the invention, but it also may be used in conjunction with other aspects of the invention. According to one aspect, the portable programming information source comprises wireless communication capability. In accordance with another aspect, it comprises a PDA or similar hand-held device. Virtually any PDA or similar hand-held device may be used, provided it is capable of storing a sufficient amount of data to perform the operations described herein and it can perform the functions for the application as generally described herein. Where a PDA is used, preferably but optionally the PDA comprises a commercially-available PDA. Examples of such commercially available PDAs would include the Zire family of PDAs from Palmone, Inc., IPAQ PDAs from Hewlett-Packard, and the like. Similar hand-held devices would include such things as cell phones and laptop or notebook computers. Examples include Nokia SMART PHONE products such as Series 60.

The use of a PDA enables the system user or other person wishing to program the target microcontroller to easily and flexibly transport a plurality of programs or programming information for a plurality of target microcontrollers in a small, hand-held device. The user can scroll through a menu of target microcontrollers and programs to select the desired ones, and then, with simple actions, quickly and efficiently program the target microcontroller wirelessly, merely by pointing the PDA at the programming tool with corresponding wireless receive capability. Using commercially available PDAs can provide further advantage, for example, by enabling the use of an inexpensive and readily available platform to perform the program information source functions.

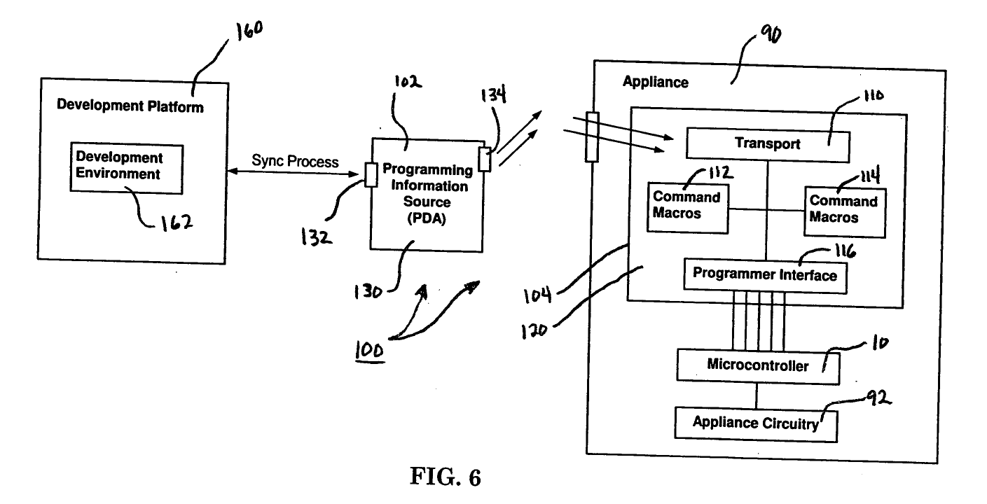

A modification or variation of the first preferred embodiment that incorporates this aspect of the invention is shown in FIG. 6. As shown in it, programming information source 102 comprises a PDA 130. PDA 130 includes a serial data connector 132, and at least one wireless communication device port 134.

PDA 130 can be detachably coupled to a development platform 160 running a development environment 162, or to another form of programming information source, via serial data connector 132. For ease and simplicity of illustration, this will simply be referred to here as the development platform 160, but it will be understood that in connection with the preferred embodiment development platform 160 can mean a programming information source such as a PC, for example, not including a full development software suite. It also will be understood that the development platform 160 as referred to in connection with this embodiment may comprise the development environment 162, a pared down version of it, or it may be excluded entirely, except for the minimum code necessary to carry out the functions as described here. In the presently preferred embodiments and implementations of the methods according to the invention, incidentally, the programming information source reflected by the development platform 160 in FIG. 6 comprises a current-version PC or similar machine, including a full development environment, and further including the support software as described in greater detail herein below.

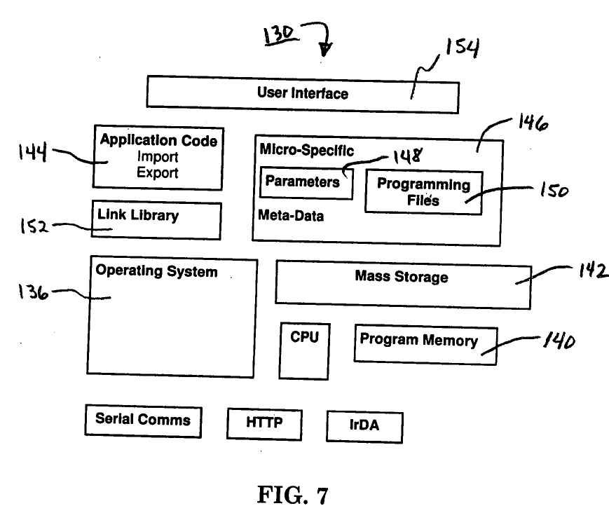

A functional block diagram of PDA 130 is provided in FIG. 7. As shown there, PDA 130 includes an operating system 136, program and/or random access memory (RAM) 140, and mass storage 142, such as a programmable flash memory or other programmable memory. Operating system 136 in PDA 132 comprises the commercially available operating system provided with PDA 132 from the PDA manufacturer. Examples would include PALM OS from PalmSource, Inc., WINDOWS CE/POCKET PC from Microsoft Corporation, and SYMBIAN from Nokia and Sony Ericsson.

A number of categories of data are stored in mass storage 142. These may include application software 144, microcontroller-specific meta data 146, which includes parameter data 148 and programming files 150, and a link library 152.

PDA 130 also comprises a user interface 154. User interface 154 includes the display of the PDA 130, and associated software and circuitry for driving it. This includes but is not limited to the screen displays as generally described herein below. User interface 154 enables the user to select a target microcontroller to be programmed, select a communications method, manage programming code, view programming code, and initiate programming activities, including such programming functions as read, erase, “blank check,” and program.

User interface 154 provides a control panel that allows the user to select the type of target microcontroller to be programmed. It also allows the user to select a desired programming code to be programmed into the target microcontroller. User interface 154 includes a suite of software utilities that enable the user to copy, cut, paste and rename files stored in PDA 130.

The application code 144 comprises the application software hosted by and run on the PDA to carry out the programming and related functions associated with the PDA's role as a programming information source. The application code 144 runs on the PDA's operating system (such as Palm or Windows CE). It fetches updated versions of programming code, parameters and meta-data. The sources of these data may be either a development environment, via a “synchronization” activity; or wireless or over-the-air downloading via a modem, the Internet or other network connection. The application code 144 also manages lists of programming code and meta-data/parameter data. The application code 144 also interacts with link library 152 to communicate with programming tool chip 120. It initiates programming activity (over-writing existing programming code), reads program memory out of the target microcontroller, erases the program memory of the microcontroller, blank checks the target microcontroller, and views details about program code, including addresses and OpCodes. In addition, the application code 144 manages communications settings (e.g., optical, IrDA, RF, etc.) In this preferred embodiment, the application software is written in C.

The meta data or parameters 146 comprise data and/or parameters specific to each supported target microcontroller, microcontroller class, etc. Table 2 provides an illustrative list of meta data and/or parameters for an illustrative set of target microcontrollers, organized in a table or flat file as they would be in the preferred embodiments and implementations.

TABLE 2
META DATA AND/OR PARAMETERS FOR ILLUSTRATIVE TARGET MICROCONTROLLERS

| | | | | Cfg | Cfg | ID | ID | EE | | | | | | | | |
|---|---|---|---|---|---|---|---|---|---|---|---|---|---|---|---|---|
| | EOM | Cal | BG | Base | Len | Base | Val | Len | [symbol] it/Word | Te | Tp | Lo Mask | Hi Mask | cmd0 | cmd1 | cmd2 |
| 12F Series: | | | | | | | | | | | | | | | | |
| 12F629 | 3FF | Y | Y | 7 | 1 | 6 | 7C | 128 | 14 | 40 | 50 | FE | 7F | 00 | 02 | 03 |
| 12F635 | 3FF | N | N | 7 | 1 | 6 | 7D | 256 | 14 | 60 | 60 | FE | 7F | 00 | 02 | 03 |
| 12F675 | 3FF | Y | Y | 7 | 1 | 6 | 7E | 128 | 14 | 40 | 50 | FE | 7F | 00 | 02 | 03 |
| 12F683 | 7FF | N | N | 7 | 1 | 6 | 94 | 256 | 14 | 60 | 60 | FE | 7F | 00 | 02 | 03 |
| 16F Series: | | | | | | | | | | | | | | | | |
| 16F627 | 3FF | No | No | 7 | 1 | 06 | 3D | 128 | 14 | 20 | 40 | FE | 7F | 00 | 02 | 03 |
| 16F627A | 3FF | No | No | 7 | 1 | 06 | 85 | 128 | 14 | 60 | 60 | FE | 7F | 00 | 02 | 03 |
| 16F628 | 7FF | No | No | 7 | 1 | 06 | 3E | 128 | 14 | 20 | 40 | FE | 7F | 00 | 02 | 03 |
| 16F628A | 7FF | No | No | 7 | 1 | 06 | 83 | 128 | 14 | 60 | 60 | FE | 7F | 00 | 02 | 03 |
| 16F630 | 3FF | Y | Y | 7 | 1 | 06 | 86 | 128 | 14 | 60 | 60 | FE | 7F | 00 | 02 | 03 |
| 16F636 | 7FF | N | N | 7 | 1 | 6 | AC | 256 | 14 | 60 | 60 | FE | 7F | 00 | 02 | 03 |
| 16F648A | FFF | No | No | 7 | 1 | 06 | 88 | 128 | 14 | 60 | 60 | FE | 7F | 00 | 02 | 03 |
| 16F676 | 3FF | Y | Y | 7 | 1 | 06 | 87 | 128 | 14 | 60 | 60 | FE | 7F | 00 | 02 | 03 |

The “model” column identifies the specific target microcontroller to be programmed. Each of these target microcontrollers would appear in the user interface displays for selection of the target microcontroller. The columnar entries for a given row provide the parameters for the target microcontroller in the “model” column. The meta data parameters comprise the values as defined by the target microcontroller manufacturer specifications. Referring to the column headings in Table 2, and to illustrate, the “Te” column provides time required or allotted to erase the target microcontroller program memory, in this instance given in hundreds of microseconds.

The programming code 150 comprises the programming codes as generated by the development platform 160 and environment 162. An example of this is an Intel Hex INHX32-compatible file.

The link library 152 comprises the operating system routines to interact and control the communications resources of the PDA to perform the actions described herein. It interacts with the PDA's available communications resources, including infrared, serial, Bluetooth, network stack and expanded storage application programming interfaces. In addition, the link library contains routines to control the programming function of the chip 120. Examples of such routines are provided in Attachments 1 through 5, which comprise commands for programming, reading, erasing, blank checking, etc. The link library is written in such a manner as to allow other applications to use the services provided by the library. This is done to facilitate product development by third parties for new applications.

PDA 130 further includes serial data transmit and receive 138 comprising or operably coupled to serial data connector 132 (e.g., USB), network communications 140 such as an HTTP-compatible Internet connection, such as a WI-FI connection, etc., and wireless communications 134, which in this embodiment may comprises a radio frequency (RF) or optical (e.g., infrared) communication subsystem.

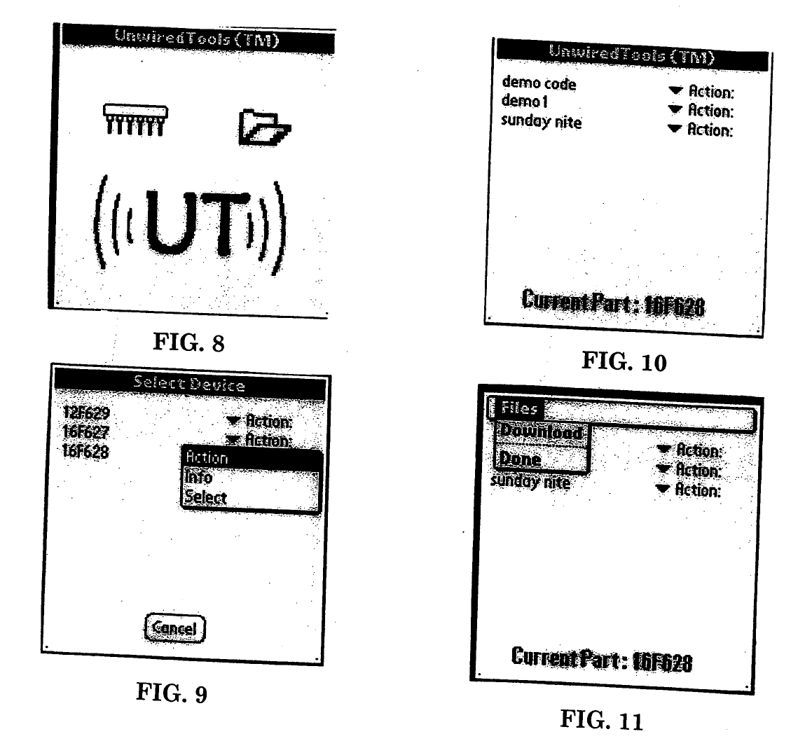

The displays shown on the screen of the PDA 130 during its operations as described herein are provided in FIGS. 8-14. FIG. 8 shows the initial screen or home page. As has been noted herein, the user may use the PDA 130 to select the particular target microcontroller and the particular program or programming information to be provided to that target microcontroller. The PDA 132 provides a screen display to support this selection, for example, as shown in FIG. 9. This screen provides only a few target microcontrollers to aid in simplicity of this illustrative example. In the presently preferred embodiment, a substantial number of target microcontrollers can be supported by a given PDA, and the fuller list would appear here. The list of target microcontrollers identified in the “model” column of Table 2 would be an example. As an option, this display may be segregated into one or more levels, directories and subdirectories, etc. to facilitate quick and efficient viewing and selection of the target microcontrollers. An initial screen, for example, may be used to identify only target microcontroller manufacturers. A second level screen then might display classes of microcontrollers for the given manufacturer. For example, if the microcontroller manufacturer is Microchip Technologies and Microchip is selected by the user at the initial screen, a second level screen would appear that lists the classes of microcontrollers offered by Microchip Technology, e.g., 12F Series, 16F Series, and so on. Upon selection of a particular class of microcontroller from this list would give rise to a third level screen listing the supported microcontrollers within that class. If the 16F Series class is selected, for example, the third level screen would list all 16F Series microcontrollers in numerical order with respect to model or part number. The user scrolls through this list or this series of lists and makes the appropriate selections so that the desired target microcontroller has been selected.

The arrangement of programs (programming code) and/or other programming information stored in the PDA 130 and available for a given target microcontroller or class of microcontrollers is provided in similar fashion. Upon selection of the desired target microcontroller, PDA 130 provides the user with a screen display of the candidate programs or programming information available for that target microcontroller. An illustrative example is provided in FIG. 10.

FIG. 11 shows the screen display on PDA 130 sued to download a new program file from a development environment, a wide area network, the Internet, or other indirect distribution source. FIG. 12 shows the screen display used to select the method or mode of wireless communication to the programming tool. FIG. 13 shows an illustrative screen displayed used to open or start communication with the programming tool. FIG. 14 shows a display used to display the program codes either read from the target microcontroller or loaded by the programming file from a development environment.

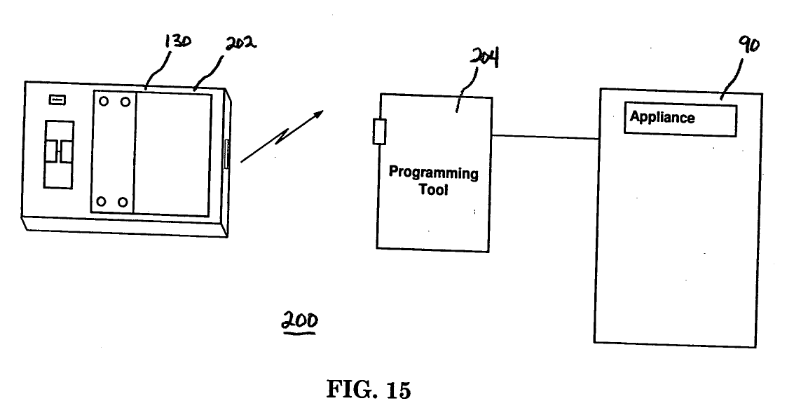

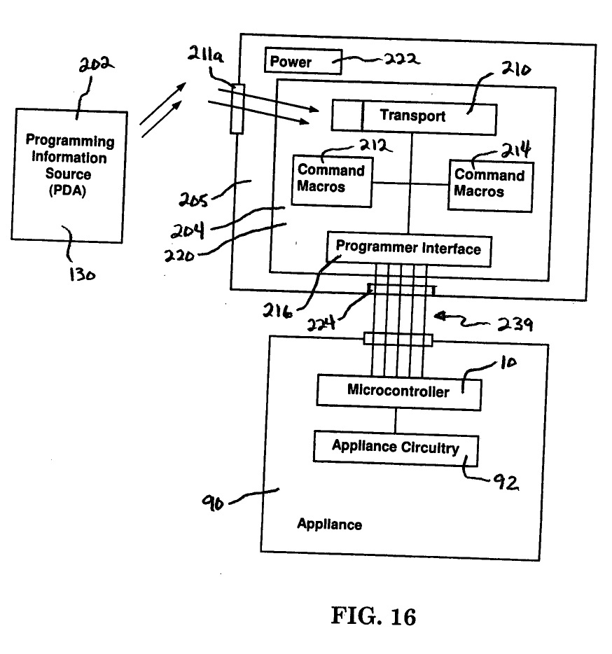

A system 200 according to another preferred embodiment of the invention is shown in FIGS. 15 and 16. System 200 comprises a programming information source 202 essentially identical to programming information source 102. System 200 further comprises a programming tool 204 essentially identical architecturally and functionally to programming tool 104.

Programming tool 204, however, is disposed on a printed circuit board 205 physically separate from the circuit board or other mounting configuration of target microcontroller 10. A microcontroller chip 220, essentially identical to chip 120 of FIG. 3, is disposed on circuit board 205. Chip 220 contains the components of programming tool 204, including a transport layer 210, a command macros memory or storage 212, a command parameters memory or storage 214, a programmer interface 216, a programming bus 239, which are essentially identical to components 110, 112, 114, 116 and 139 of FIG. 3.

Programming tool 204 further includes a transceiver 211 for receiving a wireless signal from programming information source 202. The detailed design and configuration of transceiver 211 will depend upon the wireless mode, for example, whether the signals communicated wirelessly between programming information source 202 and programming tool 204 are optical, e.g., infrared, radio frequency, etc. In the presently preferred embodiment, the communication mode used for this wireless path is a infrared, and complies with the currently-published IrDA® standard. Accordingly, transceiver 211 comprises an infrared transceiver for receiving infrared signals from programming information source 202 according to that standard and associated protocols. A window 211a is provided adjacent to transceiver 211 and is transparent or substantially so with respect to the signal being transmitted between programming information source 202 and transceiver 211.

Programming tool 204 also optionally may include a power supply 222 disposed on circuit board 205 for providing power to tool 204. Power supply 222 may comprise a battery pack with associated voltage regulation circuitry and a supply for the programming voltage.

Programming tool 204, and circuit board 205, may be located inside an appliance 90. They may be positioned adjacent to but separate from target microcontroller 10. Lines 218 may be hardwired or fixedly connected to target microcontroller 10 or its associated mounting and circuitry, or they may be detachably connected to them using a detachable connector.

Alternatively, programming tool 204 and circuit board 205 may comprise a stand-alone board. This approach is depicted in the preferred embodiment shown in FIGS. 15 and 16. In this embodiment, programming tool 204 comprises a physically separate component or tool, separate from programming information source 202 and target microcontroller 10. This separate programming tool 204 physically comprises microcontroller chip 220, IrDA transceiver 211, power supply 222, and a connector 224 for programming bus 239, all mounted on PC board 205. A cable and connector comprising programming bus 239 are used to physically and electrically connect programming tool 204 to target microcontroller 10 in use.

Programming tool 204 according to this embodiment may be used according to a presently preferred implementation of a method according to the invention, in the following manner. One first provides programming information source 202 and programming tool 204. The user physically connects programming tool 204 to target microcontroller 10 or its associated mounting or access circuitry, for example, using detachable connector 224, to connect them via programming bus 239. Programming tool 204 is appropriately powered up, for example, using power supply 222. Upon completion of initialization and reaching a ready state, the user uses programming information source 202, for example, PDA 130, to communicate programming information from the programming information source 202 to the programming tool 204 via the IrDA link. This is not, however, necessarily limiting. The wireless communication link, for example, may comprise a radio frequency design. This RF communication approach could incorporate and rely upon any one of a number of RF communications methods or standards. Examples would include but not be limited to encoding via amplitude modulation, frequency modulation or phase modulation. Standards would include but not be limited to applicable equivalents of Bluetooth, IEEE Standard 802.11a, 802.11b, 802.11g, and successors.

In accordance with another aspect of the invention, a method is provided for circular redundancy check (CRC). Before describing this method in greater detail, the following background may be helpful. The IrDA® standard promulgated by the Infrared Data Association® requires the use of a table-driven CRC method. This method is disclosed in documents published by IrDA. A lookup table is used because the algorithm specified in the standard calls for the index value of the table to be calculated by the XOR of low byte of the CRC register with the message byte itself This differs from “standard” CRC table methods that use the message byte itself as the lookup table index. Using the IrDA-published algorithm, the index value for the lookup table will not be known until the entire byte is known. Thus, a bit-wise calculation is not available.

The routine to calculate the IrDA CRC is executed once an entire byte is received. This method is easy to implement but it carries two disadvantages:
A.) The device doing the calculation has to store the CRC lookup table. For small 8-bit microcontrollers this has to be up to 50% of the total available program memory space.
B.) The time it takes to calculate the CRC value must be added to the transmission time to calculate the throughput. This after-the-fact processing decreases the speed of the communications link.

The new method in accordance with this aspect of the invention allows the CRC to be calculated on each bit as transmission or reception is underway. This is accomplished by incorporating a “standard” bit-wise CRC calculation along with the XOR of the CRC lo value at the same time. This method can eliminate the processing time of the calculation and can eliminate the need to store CRC lookup table.

Bit-wise CRC calculations are known, but this method is the first that allows for the specific requirements called for in the IrDA® Standard, without the need for a lookup table.

To facilitate description of the new method according to this aspect of the invention, we must first review the current table driven procedure in detail. A 2-byte message will be used as an example. In the review of this example, note that the IrDA CRC algorithm differs from a “standard” CRC in the following ways:
1.) The index for lookup into the CRC lookup table=[CRC(lo)] XOR [8-bit message].
2.) The initial CRC value of is set to 0xFFFF, not 0x0000.
3.) The message is fed into the CRCHI side of the CRC register, not the CRCLO side.
4.) The bit positions of the polynomial divisor is inverted, 0x8408 not 0x1021 (X¹⁶+X¹²+X⁵+1). This was done because the message byte is fed into the Reverse side of the CRC registers

5.) The resulting CRC value is complimented (XOR with 0xFFFF) before being used.

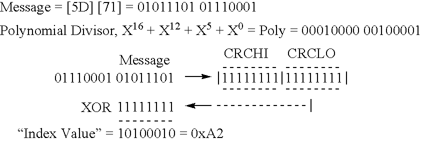

In a normal implementation, this “A2” value means that the value in the table “A2’ bytes from the beginning has the pre-calculated 16-bit value which is used as follows.
CRCLO=[CRCHI] XOR [Table lo byte]
CRCHI=[Table hi byte]

The pre-calculated table is composed by XORing and summing for each possible index value. For this example we can calculate the table value just for this index of “A2”. The procedure is to examine bit0 of the index byte. If the value is a 0, than the Poly is not XORed into the total. If the value is 1, then the Poly is used. Note that because we are using an inverted poly, the direction of the bit shift is reversed. Other than this direction shift, the method of calculating this XOR sum is the same as a standard algorithm:

Poly = 8408 = 1000 0100 0000 1000, Index = 0xA2 = 10100010

| | |
|---|---|
| Divide Index by Poly-lo (08) | Sum of the Polys |
| 10100010 0 | 0000000000000000 |
| 00000000 | |
| 1010001 1 | 1000010000001000 |
| 00001000 | |
| 100000 0 | 0000000000000000 |
| 00000000 | |
| 10000 0 | 0000000000000000 |
| 00000000 | |
| 1000 0 | 0000000000000000 |
| 00000000 | |
| 100 0 | 0000000000000000 |
| 00001000 | |
| 10 0 | 0000000000000000 |
| 00000000 | |
| 1 1 | 1000010000001000 |
| | 1000011000011000 = Table Value |

Table Value = 10000110 00011000 = 86 18
Table Lo Byte = 0x18
Table Hi Byte = 0x86

| | |
|---|---|
| CRCLO = | [CRCHI] XOR [Table lo byte], 0xFF XOR 0x18 |
| | 11111111 |
| XOR | 00011000 |
| | - - - - - - |
| CRCLO = | 11100111 = E7 |
| CRCHI = | 86 |

This new method can enable one to calculate the CRC value of each bit as it arrives or as each bit is transmitted. The index value is not known because the message byte itself is not yet known. In the preferred implementation of this method, the current bit of the message byte is examined and the value of this bit is used to develop a partial index byte. This works because the shifting intrinsic in the CRC calculation is used to mask those bits that are not yet known, and this development of a pseudo-index value happens concurrently with the summing of the shifted Poly values.

The preferred implementation of this method uses a single 8-bit working register that is loaded with the CRCLO value. When bitO of the message is received, only that one bit is XORed with the register. The register is then shifted right by one. If the bit shifted out is a 1, then the Poly is XORed and summed. At the same time, if the shifted bit is a 1, then the register is XORed with the lo byte of the Poly.

In the case of the table-driven algorithm, the index is known and shifted to develop the XOR Poly sum. This method uses the current message bit without the index to develop both the XOR sum of the Polys and the index at the same time. As the calculation proceeds, the upper bits of the working register must be ignored. These bits are indicated by an “x”. This selective disregard proceeds at the same time as further message bits are received. By selectively ignoring the unknown bits the entire message byte need not be known.

Message->01011101 -> shift the message one bit at a time for bit-wise calc
XOR with CRCLO->11111111 when a 1 is shifted out, xor working register
with poly lo
“Index Value” = 10100010
Start with msg bit0: xxxxxxx1 xor lsb shift right

| | | | | | | | | | |
|---|---|---|---|---|---|---|---|---|---|
| | CRCLO | -> | 11111111 | -> | 11111110 | -> | x1111111 0 | -> | no xor w/poly |
| | bit1: | | xxxxxxx0 | | xor lsb | | shift right | | 00001000 also |
| xor poly | | | | | | | | | |
| | | | x1111111 | -> | x1111111 | -> | xx111111 1 | -> | xx111111-> |
| xx110111 | | | | | | | | | |
| | bit2: | | xxxxxxx1 | | xor lsb | | shift right | | |
| | | | xx110111 | -> | xx110110 | -> | xxx11011 0 | -> | no xor w/poly |
| | bit3: | | xxxxxxx1 | | xor lsb | | shift right | | |
| | | | xxx11011 | -> | xxx11010 | -> | xxxx1101 0 | -> | no xor w/poly |
| | bit4: | | xxxxxxx1 | | xor lsb | | shift right | | |
| | | | xxxx1101 | -> | xxxx1100 | -> | xxxxx110 0 | -> | no xor w/poly |
| | bit5: | | xxxxxxx0 | | xor lsb | | shift right | | |
| | | | xxxxx110 | -> | xxxxx110 | -> | xxxxxx11 0 | -> | no xor w/poly |
| | bit6: | | xxxxxxx1 | | xor lsb | | shift right | | |
| | | | xxxxxx11 | -> | xxxxxx10 | -> | xxxxxxx10 | -> | no xor w/poly |
| | bit7: | | xxxxxxx0 | | xor lsb | | shift right | | 00001000 also |
| xor poly | | | | | | | | | |
| | | | xxxxxxx1 | -> | xxxxxxx1 | -> | xxxxxxxx 1 | -> | xxxxxxxx-> |
| xxxxxxxx | | | | | | | | | |

In summary, the calculation according to this preferred implementation proceeds as follows:

| Message Bit | Working Register | Sum of the Polys |
|---|---|---|
| Bit0 | 11111111 | 0000000000000000 |
| Bit1 | x1111111 | 1000010000001000 |
| Bit2 | xx110111 | 0000000000000000 |
| Bit3 | xxx11011 | 0000000000000000 |
| Bit4 | xxxx1101 | 0000000000000000 |
| Bit5 | xxxxx110 | 0000000000000000 |
| Bit6 | xxxxxx11 | 0000000000000000 |
| Bit7 | xxxxxxx1 | 1000010000001000 |
| | | 1000011000011000 |

Sum of Polys = 10000110 00011000 = 86 18

Although this preferred method is very different from the standard method above, the outcome is the same.

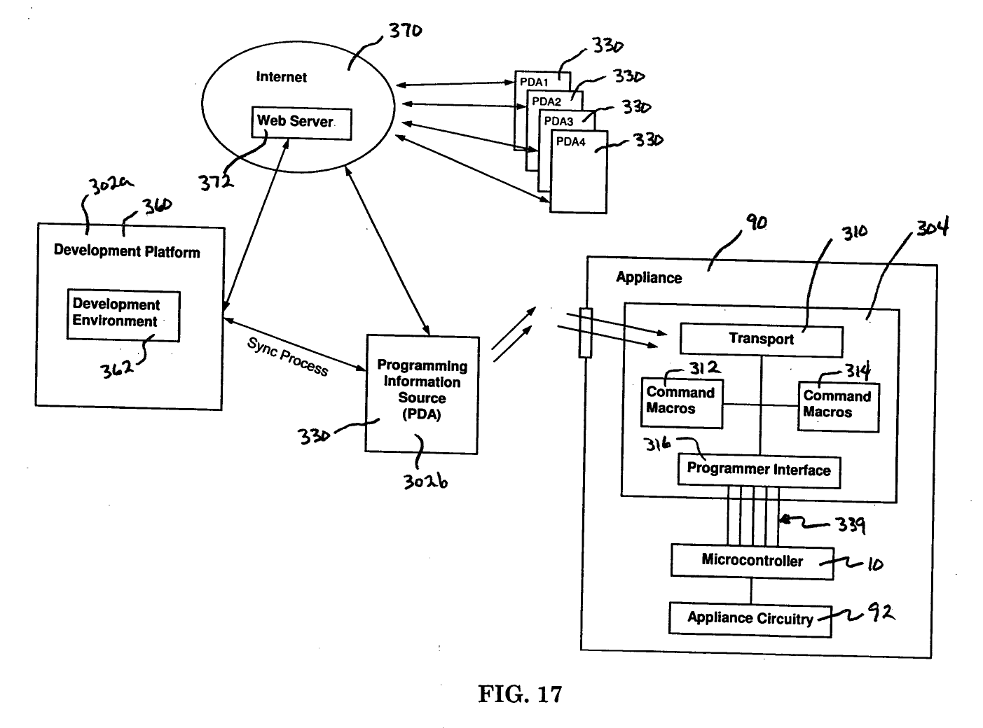

In accordance with another aspect of the invention, a system is provided for programming a target microcontroller. A system 300 according to a preferred embodiment of this aspect of the invention is shown in FIG. 17. System 300 comprises a first programming information source 302a in the form of a development platform 360 and development environment 362. Development platform 360 and development environment 362 are essentially identical to development platform 160 and development environment 162 in FIG. 3.

System 300 further comprises a second programming information source 302b for communicating programming information directly to the target microcontroller 10. Programming source 302b according to this system may comprise any of the portable programming information sources as previously described herein. In this preferred embodiment, programming information source 302b comprises a PDA 330 essentially identical to PDA 130 of FIGS. 6 and 7. That is, PDA 330 comprises the architecture and includes the structure, software and function of PDA 130. In this system embodiment, there may be, and preferably are, a plurality of PDAs structurally and functionally equivalent to PDA 330. These PDAs are denoted herein by a number designation, i.e., PDA1, PDA2, PDA3, . . .

System 300 still further comprises a programming tool 304 essentially identical to programming tool 104 of FIG. 3. Programming tool 304 comprises transport layer 310 essentially identical to transport layer 110, including its IrDA® standard compliant components. Programming tool 304 thus is capable of bidirectional wireless communication with PDA 330 via IrDA® standard infrared communication. Programming tool 304 in this embodiment is co-located with target microcontroller 10 in the interior of an appliance 90. It is positioned on a separate printed circuit board relative to microcontroller 10, but is located immediately adjacent to microcontroller 10. This position, however, is not necessarily limiting.

System 300 still further comprises a wide area communication subsystem 370 for wide area communication of programming information to and, optionally, from the PDAs 330. Wide area communication subsystem 370 may comprise any network or communication system that is capable of communicating programming information as generally described herein. This subsystem 370 may be, for example, hardwired, remote, or combinations of these. It may comprise a wide area network, the Internet, an intranet or virtual private network, or combinations of these. It also may comprise, for example, a cellular telephone or data communication system. In this presently preferred system embodiment, wide area communication subsystem 370 comprises a Web server 372 operatively coupled to the Internet. Wide area communication subsystem 370 preferably would contain and store programming code (e.g., files) and programming meta data/parameters, as described herein above.

Development platform 360 is operatively coupled at selected and desired times to the PDAs so that programming information and optionally other data may be communicated between them. This coupling may be via wired connection, including optical fiber, or it may be wireless. In the latter instance, the wireless mode may comprise optical, e.g., infrared, radio frequency, and the like. As has been described herein above, the development platform 360 and environment 362 may be used to create, test or simulate, debug, and store programs and/or other programming information that ultimately is intended for use in programming the target microcontroller 10. The development environment 362 also may be used to receive and store data from or concerning the target microcontroller, such as its hardware information, software versions, revision dates, etc. The system is configured so that one or more of the PDAs that will or may be involved in programming or otherwise servicing the target microcontroller 10 would be operatively coupled to the development platform 360 and environment 362, for example, as a prelude to a field service trip to service or upgrade microcontroller 10. This connection also may be desirable after such field service trip has occurred, e.g., to download data concerning microcontroller 10 to the development environment 362.

Development platform 360 also is operatively coupled to Web server 372 via any one or combination of means, including wired connection, optical fiber connection, WI-FI connection, and the like. Web server 372 can be used to disseminate programming code, meta-data/parameters and other programming information to a PDA 330, or to multiple PDAs 330. This can be done, for example, by forwarding the programming information to the PDA as e-mail or an e-mail attachment. Alternatively, it may be communicated as a Web page, an applet, or the like.

In a preferred method according to a related aspect of the invention, Web server 372 or its equivalent may be used to make available for downloading, e.g., subject to password protection, programming information to one or more PDAs. Similarly, the Web server 372 may be used to broadcast the programming information to the PDAs.

PDA 330 in this system embodiment can be used to communicate programming information to programming tool 304, preferably wirelessly, as has been described herein above with respect to the other embodiments, methods and aspects according to the invention.

Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

ATTACHMENT 1

```
/*
  utlink_defines.h
  */
#ifndef UTLINK_DEFINED_H
#define UTLINK_DEFINED_H
/*********************************************************************
  * Type and creator of Library database
  *********************************************************************/
#define utlinkcreatorID ‘utlK’
#define utlinkTypeID sysFileTLibrary
/*********************************************************************
  options for utlinkInit
  ********************************************************************/
```

| | | |
|---|---|---|
| #define utlinkNoTransport | 0x00000001 | // |
| nothing - just used for testing | | |
| #define utlinkIRTransport | 0x00000002 | // UT |
| raw 3 wire, lsap 2 | | |
| #define utlinkSerialTransport | 0x00000004 | // |
| cooked, wired | | |
| #define utlinkCookedTransport | 0x00000008 | // |
| cooked, irda IrComm | | |
| #define utlinkRFTransport | 0x00000010 | // UT rf |
| #define utlinkBluetoothTransport | 0x00000020 | // |
| bluetooth | | |
| #define utlinkTCPTransport | 0x00000040 | // tcp |
| of some flavor | | |
| #define utlinkDataMode | 0x00000100 | |
| #define utlinkProgramMode | 0x00000200 | |

typedef Int16 ProgramProgressF (UInt32 percentagecomplete,char *
textDescription);
typedef void LinkstatusF (UInt16 percentagecomplete,char *
textDescription);
#endif //UTLINK_DEFINED_H

ATTACHMENT 2

| /* | |
|---|---|
| UnwiredTools, LLC. | |
| Copyright 2004 | |
| Author: W.F. Ableson | |
| */ | |
| #ifndef _UTI_PROGRAMMINGSPECS_H_{—} | |
| #define _UTI_PROGRAMMINGSPECS_H_{—} | |
| #define PARAM_TE | 0 |
| #define PARAM_TP | 1 |
| #define PARAM_PROG_CYCLE | 2 |
| #define PARAM_I2C_ADDRESS | 3 |
| #ifndef_WINDOWS | |
| #define WORD UInt16 | |
| #endif | |

| typedef struct _tagDeviceParams | | |
|---|---|---|
| { | | |
| char | manufacturer[10]; | |
| char | part[20]; | |
| unsigned | char timeErase; | |
| unsigned | char timeProgram; | |
| WORD | memorySize; | |
| char | oscCalByte; | // YES OR NO FLAG |
| char | bg; | // YES OR NO FLAG |
| WORD | configBase; | |
| WORD | configLength; | |
| WORD | idBase; | |
| WORD | idValue; | |
| WORD | eeLength; | |

| | | |
|---|---|---|
| unsigned | char | bitsPerWord; |
| unsigned | char | loMask; |
| unsigned | char | hiMask; |
| unsigned | char | params[10]; |

| | |
|---|---|
| char | bulkEraseIndex; |
| char | comments[300]; |

} MICRODEVICEPARAMS;
#endif //_{——}UTI_PROGRAMMINGSPECS_H_{——}

ATTACHMENT 3

```
/*
  * utlink.h
  *
  * public header for shared library
  *
  * UnwiredTools, LLC.
  * Author: W.F. Ableson
  */
#ifndef UTLINK_H_{—}
#define UTLINK_H_{—}
/* Palm OS common definitions */
#include <SystemMgr.h>
/* If we're actually compiling the library code, then we need to
  * eliminate the trap glue that would otherwise be generated from
  * this header file in order to prevent compiler errors in CW Pro 2. */
#ifdef BUILDING_UTLINK
  #define UTLINK_LIB_TRAP(trapNum)
#else
  #define UTLINK_LIB_TRAP(trapNum) SYS_TRAP(trapNum)
#endif
#include “utlink_defines.h”
/*********************************************************************
  * Internal library name which can be passed to SysLibFind( )
  **********************************************************************/
#define utlinkName “utlinkapi”
/*********************************************************************
  * utlinkapi result codes
  * (appErrorClass is reserved for 3rd party apps/libraries.
  * It is defined in SystemMgr.h)
  *********************************************************************/
```

| | |
|---|---|
| #define utlinkErrNone | (0) |

/* invalid parameter */
#define utlinkErrParam (appErrorClass | 1)
/* library is not open */
#define utlinkErrNotOpen (appErrorClass | 2)
/* returned from utlinkClose( ) if the library is still open */
#define utlinkErrStillOpen (appErrorClass | 3)

| | |
|---|---|
| #define utlinkErrLoad | (1) |
| #define utlinkErrNotSupported | (2) |

```
/********************************************************************
  * API Prototypes
  ********************************************************************/
#ifdef _cplusplus
extern “C” {
#endif
/* Standard library open, close, sleep and wake functions */
extern Err utlinkOpen(UInt16 refNum, UInt32 * clientContextP)
  UTLINK_LIB_TRAP(sysLibTrapOpen);
extern Err utlinkClose(UInt16 refNum, UInt32 clientContext)
  UTLINK_LIB_TRAP(sysLibTrapClose);
extern Err utlinkSleep(UInt16 refNum)
  UTLINK_LIB_TRAP(sysLibTrapSleep);
extern Err utlinkWake(UInt16 refNum)
  UTLINK_LIB_TRAP(sysLibTrapWake);
/* Custom library API functions */
extern Err utlinkReadData(UInt16 refNum,UInt8 * databuffer,UInt16 *
buffersizeinout)
  UTLINK_LIB_TRAP(sysLibTrapBase + 5);
extern Err utlinkWriteData(UInt16 refNum,UInt8 * data,UInt16 length)
  UTLINK_LIB_TRAP(sysLibTrapBase + 6);
extern Err utlinkTerm(UInt16 refNum)
  UTLINK_LIB_TRAP(sysLibTrapBase + 7);
extern Err utlinkProgramFile(UInt16 refNum,char * part,char *
phex,ProgramProgressF ptr)
  UTLINK_LIB_TRAP(sysLibTrapBase + 8);
extern Err utlinkInit(UInt16 refNum,UInt32 options,LinkStatusF
  pStatusFunc)
  UTLINK_LIB_TRAP(sysLibTrapBase + 9);
extern Err utlinkErase(UInt16 refNum)
  UTLINK_LIB_TRAP(sysLibTrapBase + 10);
extern Err utlinkIoctl(UInt16 refNum)
  UTLINK_LIB_TRAP(sysLibTrapBase + 11);
extern Err utlinkGetLastError(UInt16 refNum)
  UTLINK_LIB_TRAP(sysLibTrapBase + 12);
extern Err utlinkReadFile(UInt16 refNum,char * part,UInt8 **
pData,UInt16 * pSize,UInt8 ** pEepromData,UInt16 *
pEepromSize,ProgramProgressF ptr)
  UTLINK_LIB_TRAP(sysLibTrapBase + 13);
extern Err utlinkImportHexFile(UInt16 refNum,char * part,UInt8
**ppData,UInt16 * pSize,UInt8 **ppEepromData,UInt16 *
pEepromSize,ProgramProgressF ptr,UInt8 * pHexData)
  UTLINK_LIB_TRAP(sysLibTrapBase + 14);
#ifdef _cplusplus
}
#endif
/*
  * FUNCTION: utlink_OpenLibrary
  *
  * DESCRIPTION:
  *
  * User-level call to open the library. This inline function
  * handles the messy task of finding or loading the library
  * and calling its open function, including handling cleanup
  * if the library could not be opened.
  *
  * PARAMETERS:
  *
  * refNumP
  * Pointer to UInt16 variable that will hold the new
  * library reference number for use in later calls
  *
  * clientContextP
  * pointer to variable for returning client context. The client
context is
  * used to maintain client-specific data for multiple client support.
The
  * value returned here will be used as a parameter for other library
  * functions which require a client context.
  *
  * CALLED BY: System
  *
  * RETURNS:
  * errNone
  * memErrNotEnoughSpace
  * sysErrLibNotFound
  * sysErrNoFreeRAM
  * sysErrNoFreeLibSlots
  *
  * SIDE EFFECTS:
  * *clientContextP will be set to client context on success, or zero
on
  * error.
  */
_inline Err utlink_OpenLibrary(UInt16 *refNumP, UInt32 *
clientContextP)
{
  Err error;
  Boolean loaded = false;
  /* first try to find the library */
  error = SysLibFind(utlinkName, refNumP);
  /* If not found, load the library instead */
  if (error == sysErrLibNotFound)
  {
  error = SysLibLoad(utlinkTypeID, utlinkCreatorID, refNumP);
  loaded = true;
  }
  if (error == errNone)
  {
  error = utlinkOpen(*refNumP, clientContextP);
  if (error != errNone)
  {
    if (loaded)
    {
    SysLibRemove(*refNumP);
    }
    *refNumP = sysInvalidRefNum;
  }
  }
  return error;
}
/*
  * FUNCTION: utlink_CloseLibrary
  *
  * DESCRIPTION:
  *
  * User-level call to closes the shared library. This handles removal
  * of the library from system if there are no users remaining.
  *
  * PARAMETERS:
  *
  * refNum
  * Library reference number obtained from utlink_OpenLibrary( ).
  *
  * clientContext
  * client context (as returned by the open call)
  *
  * CALLED BY: Whoever wants to close the library
  *
  * RETURNS:
  * errNone
  * sysErrParamErr
  */
_inline Err utlink_CloseLibrary(UInt16 refNum, UInt32 clientContext)
{
  Err error;
  if (refNum == sysInvalidRefNum)
  {
  return sysErrParamErr;
  }
  error = utlinkClose(refNum, clientContext);
  if (error == errNone)
  {
  /* no users left, so unload library */
  SysLibRemove(refNum);
  }
  else if (error == utlinkErrStillOpen)
  {
  /* don't unload library, but mask “still open” from caller */
  error = errNone;
  }
  return error;
}
#endif /* UTLINK_H_{—} */
```

ATTACHMENT 4

/*
utip_program.h
*/
// prototypes
Int16 utprog_MasterReset(utlinkGlobalsType * gP,UInt8 * pN);
Int16 utprog_ProgramPgmMemory(utlinkGlobalsType * gP,UInt8 *
pN,UInt16 * pData);
Int16 utprog_ProgramDataMemory(utlinkGlobalsType * gP, UInt8 *
pN, UInt8 *pData);
Int16 utprog_ReadPgmMemory(utlinkGlobalsType * gP,UInt8 *pN,UInt8
*pData);
Int16 utprog_ReadDataMemory(utlinkGlobalsType * gP,UInt8 *pN,UInt8
*pData);
Int16 utprog_IncrementAddress(utlinkGlobalsType * gP,UInt8 *pN);
Int16 utprog_SetDeviceParameters(utlinkGlobalsType * gP,UInt8
*pN,UInt8 * pData); // how do we want to break out these parameters??
Int16 utprog_SetPCToConfigMemory(utlinkGlobalsType * gP,UInt8
*pN);
// this should come from our specs database??
Int16 utprog_BulkErasePgmMemory(utlinkGlobalsType * gP,UInt8 *pN);
Int16 utprog_BulkEraseDataMemory(utlinkGlobalsType * gP,UInt8
*pN);
Int16 utprog_NoOp(utlinkGlobalsType * gP,UInt8 *pN);
Int16 utprog_WriteLiteralCommand(utlinkGlobalsType * gP,UInt8
*pN,UInt8 *pByte); // what is the ack mechanism
Int16 utprog_WriteLiteralWord(utlinkGlobalsType * gP,UInt8*
pN,UInt16 pWord);
Int16 utprog_ReadLiteralWord(utlinkGlobalsType * gP,UInt8
*pN,UInt16 * pWord);
Int16 utprog_ReadMemoryBlock(utlinkGlobalsType * gP,
UInt16 Words,UInt8 * pData, UInt16 *
pBytesRead,ProgramProgressF progress);

ATTACHMENT 5

/*
utlink_comms.h
*/
#ifndef UTLINK_COMMS_H_{—}
#define UTLINK_COMMS_H_{—}
/* crack the transport type */
#define UTLINKTRANSPORTTYPE(a) (a & 0x000000ff)
#define UTLINKMODE(a) (a & 0x0000ff00)
Int16 UT_COMMS_Establish(utlinkGlobalsType * gP,Int16
timeout,char * pszDeviceName,UInt16 * pWTxsize,UInt16 *
pWRxsize,UInt16 speed);
Int16 UT_COMMS_SendData (utlinkGlobalsType * gP,UInt8 *data,
UInt16 numBytes, Int16 *piIRState);
Int16 UT_COMMS_SendData_Flush(utlinkGlobalsType * gP);
Int16 UT_COMMS_KeepAlive(utlinkGlobalsType * gP);
void UT_COMMS_Terminate(utlinkGlobalsType * gP);
Int16 UT_COMMS_RcvData( utlinkGlobalsType * gP, UInt8 *rcvBuf,
UInt16 *bufLenP);
Int16 UT_COMMS_RcvData_Peek( utlinkGlobalsType * gP,Int16
byteswanted,UInt32 tickstowait);
Int16 UT_COMMS_RcvData_Timeout( utlinkGlobalsType * gP,Int16
byteswanted,UInt8 *rcvBuf, UInt16 *bufLenP,UInt32 tickstowait);
Int16 UT_COMMS_FlushData( utlinkGlobalsType * gP );
#endif // UTLINK_COMMS_H_{—}

What is claimed is:

1. A system for programming a target microcontroller, the system comprising:
a programming information source and a programming tool, the programming information source and the programming tool each comprising wireless communication subsystems so that the programming information source and the programming tool communicate with one another wirelessly.

2. A system as recited in claim 1, wherein the wireless communication subsystems comprise optical communication subsystems.

3. A system as recited in claim 1, wherein the wireless communication subsystems comprise infrared communication subsystems.

4. A system as recited in claim 1, wherein the wireless communication subsystems comprise radio frequency communication subsystems.

5. A system as recited in claim 1, wherein the programming tool is located adjacent to the target microcontroller.

6. A system as recited in claim 1, wherein the target microcontroller is located in an appliance, and the programming tool is located in the appliance.

7. A programming information source for programming a target microcontroller via a programming tool, the programming information source comprising a wireless communication subsystem for wirelessly communicating with the programming tool.

8. A programming tool for programming a target microcontroller in conjunction with a programming information source, the programming tool comprising a wireless communication subsystem for wirelessly communicating with the programming information source.

9. A system for programming a target microcontroller, the system comprising:
a programming information source comprising a transport layer; and
a programming tool comprising a transport layer compatible with the transport layer of the programming information source, the programming tool further comprising a plurality of command macros, a plurality of command parameters separate from the command macros, and a programmer interface.

10. A system as recited in claim 9, wherein the programming tool is located adjacent to the microcontroller.

11. A system as recited in claim 9, wherein the programming tool is located on a chip with the target microcontroller.

12. A system as recited in claim 9, wherein the programming tool is located on a printed circuit board positioned adjacent to the target microcontroller.

13. A system as recited in claim 9, wherein the programming information source and the programming tool each comprise a wireless communication subsystem for communication of wireless signals between the programming information source and the programming tool.

14. A system as recited in claim 13, wherein the wireless communication subsystem comprises circuitry for wireless communication using optical signals.

15. A system as recited in claim 13, wherein the wireless communication subsystem comprises circuitry for wireless communication using infrared signals.

16. A system as recited in claim 13, wherein the wireless communication subsystem comprises circuitry for wireless communication using radio frequency signals.

17. A system as recited in claim 9, wherein the programming information source comprises a personal data accessory.

18. A programming tool for use in programming a target microcontroller, the programming tool comprising:
a transport layer;
a processor;
storage for a plurality of command macros;
storage for a plurality of command parameters separate from the command macros; and
a programmer interface.

19. A programming tool as recited in claim 18, further comprising a wireless communication subsystem for communication of wireless signals.

20. A programming tool as recited in claim 19, wherein the wireless communication subsystem comprises circuitry for wireless communication using optical signals.

21. A programming tool as recited in claim 19, wherein the wireless communication subsystem comprises circuitry for wireless communication using infrared signals.

22. A programming tool as recited in claim 19, wherein the wireless communication subsystem comprises circuitry for wireless communication using radio frequency signals.
